(19) United States
(12) Patent Application Publication
(10) Pub. No.: US 2007/0108303 A1
(43) Pub. Date: May 17, 2007

(54) Modular display and control unit

(75) Inventor: Ming-Jen Tsao, Hsin Chu (TW)

Correspondence Address: Troxell Law Office PLLC;Suite 1404, 5205 Leesburg Pike, Falls Church, VA, 22041, US

(73) Assignee: Ace Dragon Corp.

(21) Appl. No.: 11/274,118

(22) Filed: Nov. 16, 2005

(51) Int. Cl. F24F 3/14; G05D 23/00

(52) U.S. Cl. 236/44 C; 236/94

(57) ABSTRACT

A modular display and control unit is mounted in an electrical apparatus. The modular display and control unit has a control module, a sensing module, a display module, a first connecting interface, a second connecting interface and a mounting device. The modular display and control unit can be detached from the electrical apparatus for cleaning, maintenance or repair. After a unit is removed, another identical modular display and control unit can be mounted in the electrical apparatus to maintain the continuous operation without needing to completely lose the use of the entire apparatus.

### BACKGROUND OF THE INVENTION

1. Field of the Invention

The present invention relates to a temperature/humidity-regulating apparatus, and in particular to a regulating apparatus having a modular display and control unit.

2. Description of the Related Art

In damp environments, the humidity in the atmosphere can easily cause undesirable damage, such as oxidation, rust or mildew, to metals and electronic components. In the electronics industry, the humidity must be precisely controlled to assure the quality of the manufactured electronic products. Production methods involving high precision rely on the precise control of environmental conditions. Therefore, humidity-regulating equipment is widely used in electronics factories.

A humidity-regulating apparatus is mainly comprised of a display device, sensors and a temperature/humidity control device. The sensors gather readings of the surrounding environmental conditions, such as temperature and humidity. After comparing the readings with set values, the temperature/humidity control device will determine whether or not to regulate the present environmental conditions. The collected information is presented on the display device. In most temperature/humidity regulating apparatuses, the display and control devices are usually integral parts and cannot be removed. In the event of any failure in the components of the apparatus, such as the sensors or the display device, a maintenance operator must move the entire regulating apparatus from the factory to make repairs. If the repair work cannot be finished in a timely manner, the factory would be without the use of the humidity-regulating apparatus and possible damage during the production process may occur.

### SUMMARY OF THE INVENTION

An objective of the present invention is to provide a modular display and control unit that can be installed in a temperature/humidity regulating apparatus, wherein the modular display and control unit can be easily detached from or installed in the temperature/humidity regulating apparatus.

In addition, when a modular display and control unit is removed from the temperature/humidity regulating apparatus to be repaired, an identical unit can be installed to replace the original unit to maintain the continuous operation of the regulating apparatus without the need to completely remove the entire apparatus from the factory and lose its use.

The modular display and control unit is installed in an electrical apparatus, and has a control module, a sensing module, a display module, a first connecting interface, a second connecting interface and a mounting device.

Operation parameters to regulate the environmental conditions are set to the desired values with the control module. The sensing module monitors the status of surrounding environment. The display module presents the environmental status detected by the sensing module. The first connecting interface serves as a data transmission interface that is connected to a data-collecting unit. The second connecting interface is connected to the temperature/humidity regulating apparatus. The mounting device allows the modular display and control unit to be mounted in the apparatus.

The features and structure of the present invention will be more clearly understood when taken in conjunction with the accompanying drawings.

### BRIEF DESCRIPTION OF THE DRAWINGS

FIG. 1 is a front perspective view of a modular display and control unit in accordance with the present invention;

FIG. 2 is a rear perspective view of the modular display and control unit in FIG. 1;

FIG. 3 is an operational top view in partial section of the installation of a modular display and control unit in accordance with the present invention in an electrical apparatus;

FIG. 4A is an operational top view in partial section of the installation of an alternative embodiment of a modular display and control unit in accordance with the present invention in an electrical apparatus;

FIG. 4B is a top view in partial section of the modular display and control unit in FIG. 4A installed in the electrical apparatus;

FIG. 5 is a system block diagram of the modular display and control unit in accordance with the present invention;

FIG. 6 is an operational perspective view of the installation of the modular display and control unit in accordance with the present invention in an electrical apparatus;

FIG. 7A is an operational perspective view of the modular display and control unit in FIG. 6; and

FIG. 7B is a rear perspective view of the electrical apparatus of FIG. 7A.

### DETAILED DESCRIPTION OF THE PREFERRED EMBODIMENT

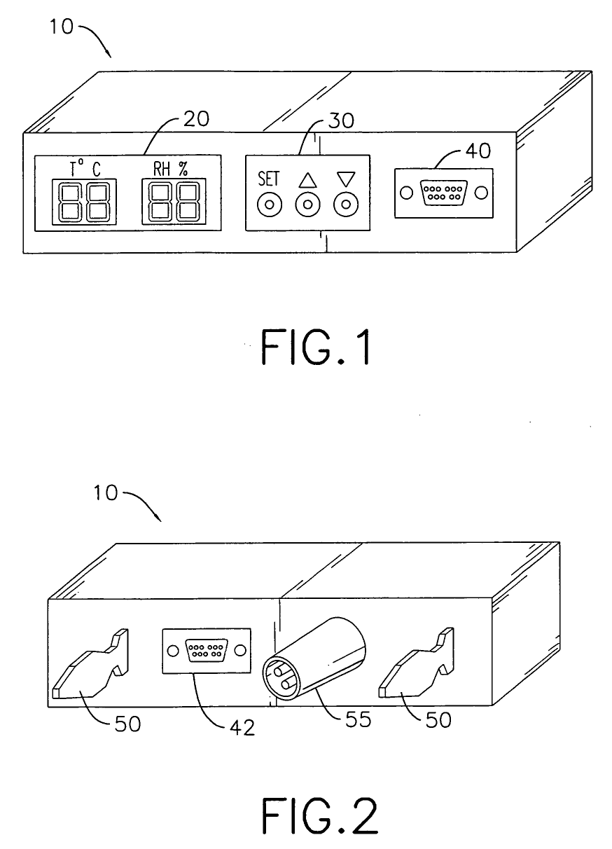

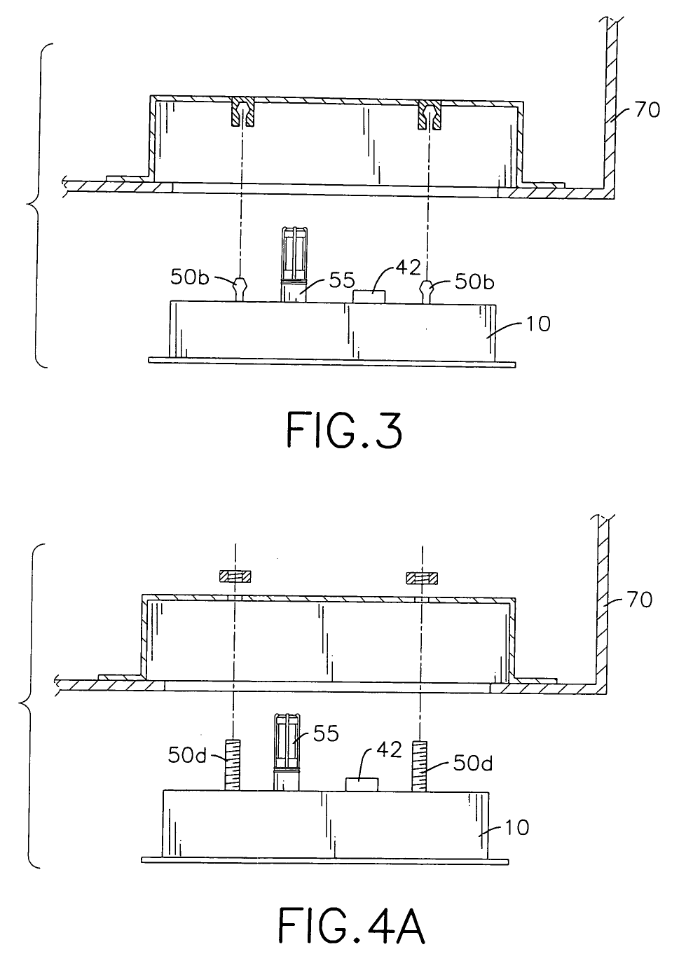

With reference to FIGS. 1 and 3, a modular display and control unit (10) in accordance with the present invention can be installed in an electrical apparatus (70) to display and monitor environment parameters that are regulated by the electrical apparatus (70). The modular display and control unit (10) comprises a display module (20), a control module (30) and a first connecting interface (40). The display module (20) can include a temperature display unit and a humidity display unit. The display module (20) can be accordingly modified by adding other types of display units if other environment parameters are to be monitored and/or regulated by the electrical apparatus. For example, if a gas concentration or particulates concentration should be monitored, additional display units for gas concentration and particulates concentration will be added. The control module (30) is used to set the required parameters to control the environmental conditions. The first connecting interface (40) serves as a data transmission and control interface to connect the modular display and control unit (10) to a data collecting and processing unit (not shown). The data collecting and processing unit can be a computer.

With reference to FIG. 2, a rear side of the modular display and control unit (10) has a second connecting interface (42), a mounting device (50) and a sensing module (55). The sensing module (55) is comprised of multiple sensors to detect temperature and humidity. The second connecting interface (42) connects the modular display and control unit (10) to the electrical apparatus. With reference to FIG. 3, the mounting device (50), such as a pair of prongs (50b), allows the modular display and control unit (10) to be installed in an electrical apparatus (70).

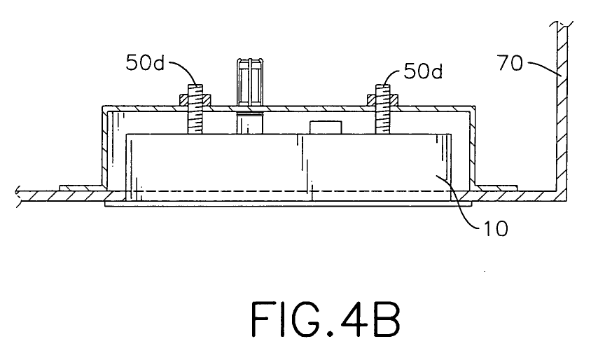

The mounting device (50) may also be a screw-type element (50d) as shown in FIGS. 4A and 4B or a magnetic-type connecting element. In the present invention, the display module (20) can be an LED display or an LCD display. The first and second connecting interfaces (40)(42) can be RS-232 interfaces or USB interfaces. The first connecting interface (40) can also be a wireless transmission interface.

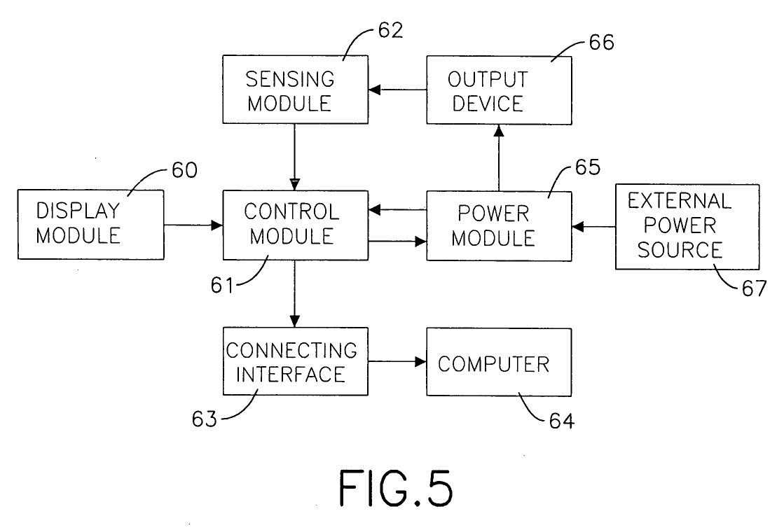

With reference to FIG. 5, in the modular display and control unit of the present invention, a control module (61) is coupled to a display module (60), a sensing module (62), a connecting interface (63) and a power module (65). An output device (66) connects to the power module (65). A computer (64) can be connected to the connecting interface (63). The sensing module (62) detects the temperature and humidity of the surrounding environment and then transmits the detected readings to the control module (61). The control module (61) processes the data and outputs the real temperature and humidity values to be displayed on the display module (60). The power module (65) is connected to an external power source (67) to supply operating power to the control module (61) and the output device (66). Based on the difference between the set parameter values and the detected values, the control module (61) can properly activate the output device (66). The output device (66) can be a humidifier, an exsiccator, a heating device or a cooling device. The control module (61) can activate or deactivate the output device (66) to regulate the temperature or humidity of the surrounding environment. The sensing module (62) constantly monitors the temperature and humidity conditions and transmits these readings to the control module (61), which activates and deactivates the output device (66) until the desired environmental conditions are met. The external computer (64) can access the temperature and humidity data of the control module (61) through the connecting interface (63) whereby an operator can control the environmental conditions.

The display module (60), the control module (61), the sensing module (62) and the connecting interface (63) are all integrated to form the modular display and control unit. The control module (61) includes a setting unit to set the required temperature and humidity values, and has an interface connected between the control module (61) and the power module (65).

The above-mentioned modular display and control unit can detect the temperature and humidity of the surrounding environment and control the output device to regulate the temperature and humidity conditions. The modular display and control unit can be connected to an external computer and output the collected data to the computer. Moreover, the modular display and control unit can be installed in a humidity regulating apparatus to control the power module in the apparatus thereby adjusting the temperature/humidity by activating/deactivating the output device (humidifier, exsiccator, heating device or cooling device). Furthermore, the modular display and control unit and the power module can be assembled together. The combination can be connected to an external humidifier, exsiccator, heating device or cooling device to regulate the temperature/humidity inside a closed space.

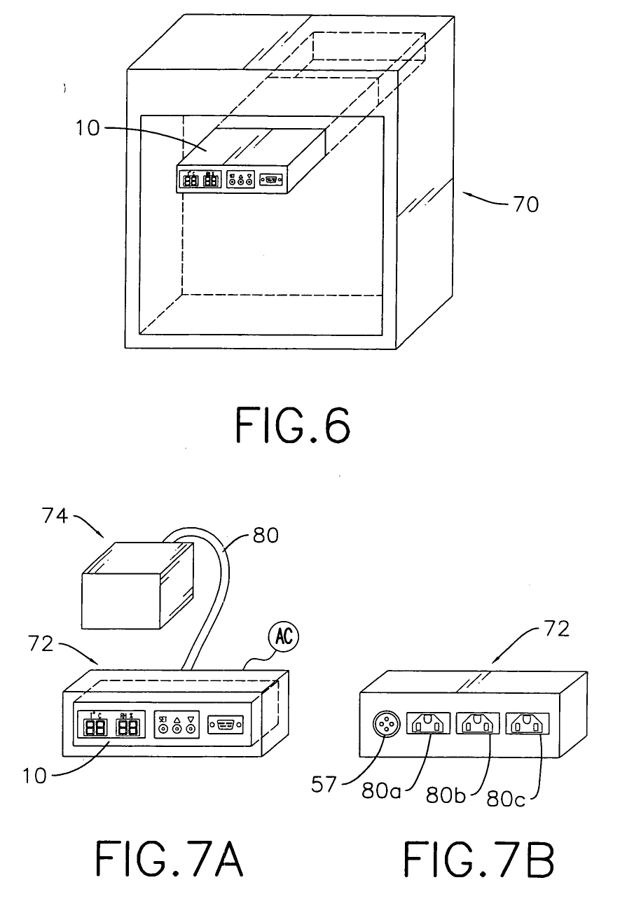

With reference to FIG. 6, the electrical apparatus is a storage device (70) capable of regulating the temperature/humidity, such as a moisture-proof coffer or cabinet. The modular display and control unit (10) is installed inside the storage device (70) to display and regulate the temperature/humidity. The modular display and control unit (10) is connected to the power module of the storage device (70). The modular display and control unit (10) can also be removed from the storage device (70) for repair, and at the same time another identical modular display and control unit can be installed in the storage device (70) to maintain the regular operation.

With reference to FIG. 7A, the modular display and control unit (10) is installed in an electrical apparatus such as a power module (72). The power module (72) is electrically connected to an external temperature/humidity regulating device (74) through wires (80) to adjust the temperature/humidity inside a closed space. The temperature/humidity regulating device (74) can be a humidifier, exsiccator, heating device or cooling device. If different parameters are to be monitored and controlled, the regulating device (74) may be of a different type, for example, gas or particulate control devices.

With reference to FIG. 7B, when the modular display and control unit (10) is installed in the power module (72), a sensing area (57) having a sensing unit (55)(as shown in FIG. 2) is exposed to detect the temperature, humidity and other environment status. The power module (72) has multiple power input/output ports (80a, 80b, 80c). The input port connects to an external power source to receive AC power. The output ports can be respectively connected to a humidifier, exsiccator, heating device or cooling device. The modular display and control unit (10) can control the power module (72) to turn on or turn off the humidifier, exsiccator, heating device or cooling device connected to the power output ports. The modular display and control unit (10) can be easily detached from the power module (72) by any user without professional training. If the sensors in the modular display and control unit (10) needed to be regularly maintained or repaired, the user only has to remove the module (10) and send it back to the manufacturer. Meanwhile, a replacement module (10) can be installed in the power module (72) to maintain the regular operation without having to lose the use of the apparatus.

In conclusion, the advantage of the present invention is that when a modular display and control unit must be removed from an apparatus for cleaning, maintenance or repair, a replacement module can be easily installed in the apparatus eliminating the need to remove the entire apparatus and losing the use of the apparatus.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A modular display and control unit mounted in an electrical apparatus, the modular display and control unit comprising:
a control module with a setting unit, wherein operation parameters are set to regulate environmental conditions controlled by the electrical apparatus;
a sensing module to detect the status of the environmental conditions;
a display module to display the status of the environment conditions detected by the sensing module;
a first connecting interface as a data transmission interface to be connected to a data collecting unit;
a second connecting interface to be connected to the electrical apparatus;
a mounting device to mount the modular display and control unit in the electrical apparatus.

2. The modular display and control unit as claimed in claim 1, wherein the electrical apparatus is a storage device capable of regulating temperature and humidity.

3. The modular display and control unit as claimed in claim 1, wherein the electrical apparatus is a storage device capable of regulating temperature and humidity used in a closed space.

4. The modular display and control unit as claimed in claim 1, the sensing module comprising multiple sensors to detect temperature and humidity.

5. The modular display and control unit as claimed in claim 1, the display module comprising a temperature display unit and a humidity display unit.

6. The modular display and control unit as claimed in claim 1, wherein the display unit is an LED display or an LCD display.

7. The modular display and control unit as claimed in claim 1, wherein the first connecting interface is an RS-232 interface or a USB interface.

8. The modular display and control unit as claimed in claim 1, wherein the second connecting interface is an RS-232 interface or a USB interface.

9. The modular display and control unit as claimed in claim 1, wherein the data collecting unit is a computer.

10. The modular display and control unit as claimed in claim 1, wherein the mounting device is a screw-type element, a magnetic-type connecting element or a prong.
